(19) United States
(12) Patent Application Publication
(10) Pub. No.: US 2008/0126217 A1
(43) Pub. Date: May 29, 2008

(54) METHOD FOR ARRANGING TRIALS OF A MERCHADIZE

(76) Inventor: Peigen Jiang, Sammamish, WA (US)

Correspondence Address: PEIGEN JIANG, 19480 SE 28TH PLACE, SAMMAMISH, WA, 98075, US

(21) Appl. No.: 11/564,292

(22) Filed: Nov. 29, 2006

(51) Int. Cl. G06Q 30/00

(52) U.S. Cl. 705/26; 705/1; 705/35

(57) ABSTRACT

A method for arranging trials of a merchandise is disclosed, which comprises collecting addresses of a first and second trial customer over a communication means, shipping the merchandise to a first trial customer for a trial of the same by the first trial customer, and instructing a transportation of the merchandise from the first trial customer directly to the second trial customer upon an end of the trial.

### BACKGROUND

The present invention relates generally to commercial retail methods, and more particularly, to a method for arranging trials of merchandises.

The Internet has brought many changes to the retail industry. A customer can read an excerpt of a book or listen to a portion of a song, all over the Internet, before buying it. The customers do not have to go to a store to physically see the products. This creates a direct sales channel for these products, very much like a traditional catalog mail order business. But certain merchandizes, such as high-end audio and video products, are quite subjective to personal tastes. Most customers prefer to physically try out these products before committing to buy them. For these merchandises, their vendor traditionally signs up local stores to demonstrate them to customers in their respective locales.

In a fragmented marketplace, however, the traditional sales channel has many disadvantages. First, signing up local stores for a less established vendor is both time consuming and very costly. Second, a store demonstration environment may be different from a home environment of a potential customer that may create a mismatch of expectations. Third, selling through local stores will inevitably raise prices of the merchandises, and makes them less competitive.

As such, what is desired is a method for arranging trials of merchandises in a customer's home and preserving direct sales' reach and efficiency.

### SUMMARY

In view of the foregoing, the present invention provides a method for arranging trials of a merchandise which comprises collecting addresses of a first and second trial customer, shipping the merchandise to a first trial customer for a trial of the same by the first trial customer, and instructing a transportation of the merchandise from the first trial customer to the second trial customer upon an end of the trial by the first customer.

According to one aspect of the present invention, the communication means is the Internet. According to another aspect of the present invention, the method may further comprise soliciting one or more trial customers as well as selling the merchandise over the Internet.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 illustrates a distribution channel of a sample merchandise according to one embodiment of the present invention.

FIG. 2 is a flow chart illustrating steps of arranging trials of the sample merchandise for two or more trial customers in a close proximity according to the embodiment of the present invention.

### DESCRIPTION

The following will provide a detailed description of a method for arranging trials of a merchandise, which may facilitate sales of the same. The arranging trial method allows the merchandise to reach a large number of potential customers without enlisting any local retail facilities.

In order to attract potential customers, a vendor may set up a world wide web site (website) to display its merchandizes as well as to allow a potential customer to sign up for a trial of the merchandise. In order to become a trial customer, a person enters his/her address into the website, and agrees to certain terms set up by the vendor, such as shipping back or delivering to a local address after his/her trial period ends. In some cases, the vendor may charge a fee for trying on certain merchandizes based on a number of days a trial customer keeps the merchandise. The vendor may also want to collect credit card information as a preventive measure against possible fault in part of the trial customers. Both the charging fee and collecting credit card information may be implemented through the website. The vendor may choose to retain its right to refuse a trial request.

When the number of trial customers in a locale has passed a predetermined level, the vendor may ship a sample merchandise to a first trial customer in that locale.

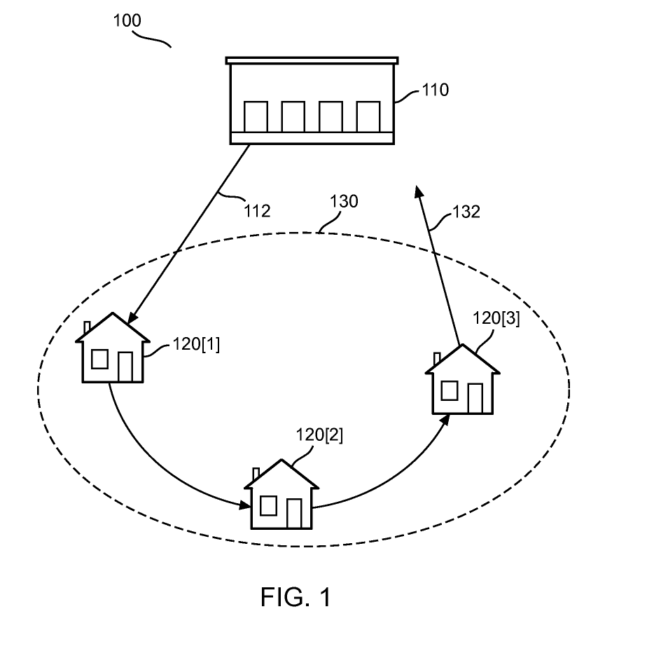

FIG. 1 illustrates a distribution channel 100 of the sample merchandize. The distribution channel 100 comprises a vendor's warehouse 110, and closely located trial customers 120[1:3] in a locale 130. The locale 130 may be a metropolitan area, which may be hundreds of miles away from the vendor's warehouse 110.

Referring to FIG. 1, the sample merchandise is first shipped from the vendor's warehouse 110 to the first trial customer 120[1] by a common carrier 112, such as the United States Postal Service. The first trial customer 120[1] keeps the sample merchandise for a first predetermined period of time, for instance one day, for trying out the sample merchandise. After that, the first trial customer 120[1] transports the sample merchandise directly to a second trial customer 120[2], which may be the closest trial customer to the first trial customer 120[1]. Here, the word “directly” means that the sample merchandise is transported to the second trial customer without being possessed by either the vendor or any other person except the first trial customer or a designated carrier. The address of the second trial customer 120[2] is provided to the first trial customer 120[1] by the vendor. Since the first and second trial customers 120[1:2] are closely related. The first trial customer 120[1] may personally deliver the merchandise to the second trial customer 120[2], or hire a local carrier to deliver it at his or her own expense as he or she may have so agreed with the vendor.

Similarly, the second trial customer 120[2] keeps the sample merchandize for a second predetermined period of time for trying out the same. After that, the second trial customer 120[2] transports the sample merchandize directly to a third trial customer 120[3], whose address is also provided to the second trial customer 120[2] by the vendor.

After trying the sample merchandize, the trial customer 120[1, 2 or 3] may go to the vendor's website to order a merchandize the sample merchandize represents, if he or she likes the sample merchandize. Then a brand new merchandize will be shipped to him or her by the vendor. Otherwise, the trial customer 120[1, 2 or 3] may only lose a small trial fee, and a local trip to deliver the sample merchandize to a next trial customer.

Referring to FIG. 1, if, after the third trial customer 120[3] tries out the sample merchandize, there is no more trial customer located in or near the locale 130. The third trial customer 120[3] may be instructed to ship the sample merchandize either back to the warehouse 110 or a trial customer in another locale by another common carrier 132 at the vendor's cost. The vendor may also request the third trial customer 120[3] to keep the sample merchandize for free until a new trial customer in or near the locale 130 has developed. Then the third trial customer 120[3] will be asked to deliver the sample merchandize to the new trial customer.

Although only three trial customers 120[1:3] are illustrated in FIG. 1, one having skill in the art would realize such distribution channel 100 may sign up much greater number of trial customers. The exact number of trial customers one sample merchandize can serve depends on the number of days each trial customer has signed up. If there are too many trial customers signed up in a locale, the vendor may ship more than one sample merchandizes to circulate in that locale.

Damages may occur to the sample merchandize during a circulation. The vendor may choose not to charge the trial customer in possession of the sample merchandize when the damages happen, as long as he or she ships the sample merchandize back to the warehouse 110. The vendor may either insure against any lose due to the damages or simply write it off as a cost of doing business.

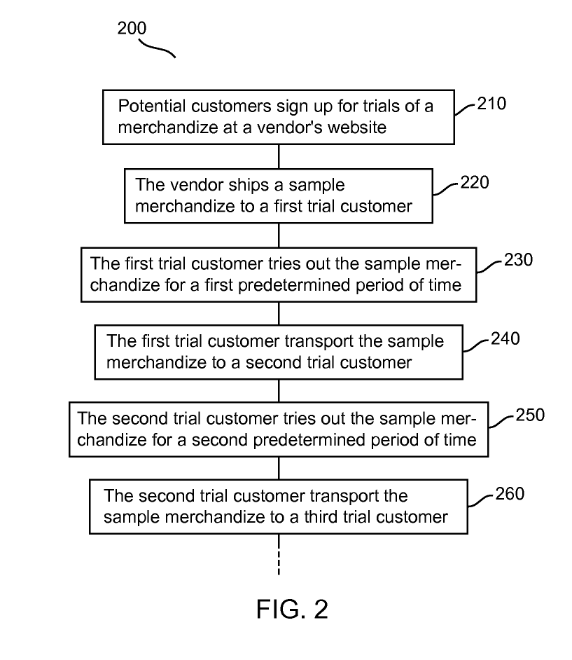

FIG. 2 is a flow chart 200 illustrating essential steps of arranging trials of the sample merchandize by two or more trial customers in a close proximity. In step 210, potential customers who are interested in a merchandize displayed in a vendor's website may sign up for trials of the merchandize. With enough number of trial customers in a close proximity to justify the cost of shipping a sample merchandize to the trial customers, the vendor may ship a sample merchandize to a first trial customer in step 220. Then the first trial customer has a chance to trying out the sample merchandize in his or her home environment for a first predetermined period of time in step 230. After that, the first trial customer transports the sample merchandize to a second trial customer in the close proximity in step 240. Since the first and second customers are located in the close proximity, the transporting the sample merchandize to the second trial customer may simply be implemented by a personal delivery by the first trial customer. In step 250, the second trial customer tries out the sample merchandize for a second predetermined period of time in his or her home environment. Then the second trial customer transports the sample merchandize to a third trial customer in step 260. The addresses of both the second and third trial customers are provided to the first and second trial customers, respectively, by the vendor. People having skills in the art would realize that the number of trial customers may well be extended to beyond three.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method for arranging trials of a merchandise, the method comprising:
collecting addresses of a first and second trial customer over a communication means;
shipping the merchandise to a first trial customer for a trial of the same by the first trial customer; and
instructing a transportation of the merchandise from the first trial customer directly to the second trial customer upon an end of the trial.

2. The method of claim 1, wherein the first and second trial customers are located within a predetermined distance.

3. The method of claim 2, wherein the predetermined distance is approximately 20 miles.

4. The method of claim 1, wherein the communication means is the Internet.

5. The method of claim 1 further comprising soliciting one or more trial customers on the Internet by a vendor of the merchandise.

6. The method of claim 1 further comprising selling the merchandise on the Internet by the vendor.

7. The method of claim 1, wherein the instructing comprises:
informing an address of the second trial customer to the first trial customer;
requiring the first trial customer to transport the merchandise to the address of the second trial customer.

8. The method of claim 1 further comprising collecting a trial fee by a vendor of the merchandise from the first and second trial customer.

9. A method for arranging trials of a merchandise, the method comprising:
collecting addresses of a first and second trial customer over a communication means, wherein the first and second trial customers are located within a predetermined distance;
shipping the merchandise to a first trial customer for a trial of the same by the first trial customer; and
instructing a transportation of the merchandise from the first trial customer directly to the second trial customer upon an end of the trial.

10. The method of claim 9, wherein the predetermined distance is approximately 20 miles.

11. The method of claim 9, wherein the communication means is the Internet.

12. The method of claim 9 further comprising soliciting one or more trial customers on the Internet by a vendor of the merchandise.

13. The method of claim 9 further comprising selling the merchandise on the Internet by the vendor.

14. The method of claim 9, wherein the instructing comprises:
informing an address of the second trial customer to the first trial customer;
requiring the first trial customer to transport the merchandise to the address of the second trial customer.

15. The method of claim 9 further comprising collecting a trial fee by a vendor of the merchandise from the first and second trial customer.

16. A method for arranging trials of a merchandise, the method comprising:
collecting addresses of a first and second trial customers over the Internet, wherein the first and second trial customers are located within a predetermined distance;
shipping the merchandise to a first trial customer for a trial of the same by the first trial customer; and
instructing a transportation of the merchandise from the first trial customer directly to the second trial customer upon an end of the trial.

17. The method of claim 16, wherein the predetermined distance is approximately 20 miles.

18. The method of claim 16 further comprising:
soliciting one or more trial customers on the Internet by a vendor of the merchandise; and
selling the merchandise on the Internet by the vendor.

19. The method of claim 16, wherein the instructing comprises:
informing an address of the second trial customer to the first trial customer;
requiring the first trial customer to transport the merchandise to the address of the second trial customer.

20. The method of claim 16 further comprising collecting a trial fee by a vendor of the merchandise from the first and second trial customer.
